(19) United States
(12) Patent Application Publication
(10) Pub. No.: US 2025/0160580 A1
(43) Pub. Date: May 22, 2025

(54) FOUR-WAY PIVOT DOOR

(71) Applicant: Kohler Co.

(72) Inventors: Giacomo Schiaroli, Senigallia (IT); Jacob David Lockhart, Troy, TN (US); Nameer Shaaban, Lewiston, NY (US); Alexandra Marie Lewis, Paris, TN (US)

(73) Assignee: Kohler Co., (US)

(21) Appl. No.: 18/943,162

(22) Filed: Nov. 11, 2024

Related U.S. Application Data
(60) Provisional application No. 63/599,713, filed on Nov. 16, 2023.

(51) Int. Cl. A47K 3/36; E06B 7/23

(52) U.S. Cl. CPC A47K 3/362; E06B 7/231; E05Y 2900/114

(57) ABSTRACT

A shower door system includes a wall assembly configured fixedly couple the shower door system to walls of a showering enclosure. The shower door system includes a fixed panel coupled to the wall assembly and a door panel pivotably coupled to the wall assembly by a pivot assembly defining a pivot axis. The door panel is configured to pivot about the pivot axis between an open position and a closed position. An overlap jamb is coupled to the wall assembly adjacent a pivoting end of the door panel, the overlap jamb defining a coupling surface that is couplable to the showering enclosure, in a first configuration, and couplable to the fixed panel, in a second configuration.

### CROSS-REFERENCE TO RELATED APPLICATIONS

The present application claims the benefit of priority to U.S. Provisional Application No. 63/599,713, filed Nov. 16, 2023, the entire contents of which are incorporated herein by reference.

### BACKGROUND

The present disclosure relates generally to a shower door. More specifically, the present disclosure relates to a shower door assembly that may be installed to allow users to access a shower space from the right or left side, and may be installed to pivot about the center of the shower door assembly or a wall.

Different shower door configurations are needed to adapt to different bathroom layouts to provide access to the shower space. Typically, different shower door configurations are sold as separate, individual shower door assemblies, and may require different components.

### SUMMARY

One embodiment of the present disclosure relates to a shower door system including a wall assembly. The wall assembly is configured to fixedly couple the shower door system to walls of a showering enclosure. The shower door system includes a fixed panel coupled to the wall assembly and a door panel pivotably coupled to the wall assembly by a pivot assembly defining a pivot axis. The door panel is configured to pivot about the pivot axis between an open position and a closed position. An overlap jamb is coupled to the wall assembly adjacent a pivoting end of the door panel, the overlap jamb defining a coupling surface couplable to the walls of the shower enclosure, in a first configuration, and couplable to the fixed panel, in a second configuration.

Another embodiment relates to a shower system including a showering enclosure and a wall assembly. The wall assembly is configured to be coupled to support walls of the showering enclosure, and includes a header, a threshold, and at least one wall jamb. The shower system includes a fixed panel coupled to the wall assembly and a door panel pivotably coupled to the wall assembly by a pivot assembly defining a pivot axis. The door panel is configured to pivot about the pivot axis between an open position and a closed position. The shower system further includes an overlap jamb coupled to the wall assembly adjacent a pivoting end of the door panel, the overlap jamb defining a coupling surface couplable to the at least one wall jamb, in a first configuration, and couplable to the fixed panel, in a second configuration.

Another embodiment relates to a shower door system including a wall assembly configured to support and couple a pivot door assembly to a showering enclosure defining an opening. The wall assembly is configured to secure to walls of the shower enclosure and includes an overlap jamb movable between a first configuration and a second configuration. The overlap jamb includes a member having a substantially flat front surface and a coupling surface opposite the front surface, the coupling surface being coupled to the walls of the shower enclosure in the first configuration. The overlap jamb also includes an attachment member extending away from the front surface and forms a channel. A fixed panel is coupled to the wall assembly, wherein the attachment member is configured to receive the fixed panel in the channel in the second configuration. A door panel is pivotably coupled to the wall assembly by a pivot assembly defining a pivot axis, the pivot axis being parallel to and adjacent to a length of the overlap jamb. The door panel is configured to pivot about the pivot axis between an open position and a closed position.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. Understanding that these drawings depict only several implementations in accordance with the disclosure and therefore, not to be considered limiting of its scope, the disclosure will be described with additional specificity and detail through use of the accompanying drawings.

FIG. 1 shows a front view of a shower door system in a left entry with wall pivot configuration, according to an exemplary embodiment;

FIG. 2 shows a front view of a shower door system in a left entry with center pivot configuration, according to an exemplary embodiment;

FIG. 3 shows a front view of a shower door system in a right entry with wall pivot configuration, according to an exemplary embodiment;

FIG. 4 shows a front view of a shower door system in a right entry with center pivot configuration, according to an exemplary embodiment;

FIG. 5 shows a top perspective view of the pivot door assembly of the shower door system of FIG. 2;

FIG. 6 shows a perspective view of a top portion of the shower door system of FIG. 3 in closed position;

FIG. 7 shows a perspective view of the shower door system of FIG. 6, in an open position;

FIG. 8 shows a front view of a shower door system, according to an exemplary embodiment;

FIG. 9 shows a back view of the shower door system of FIG. 8;

FIG. 10 shows a cross-sectional view of a top portion of a pivot door assembly of a shower door system, according to an exemplary embodiment;

FIG. 11 shows a top cross-sectional view of a fixed panel to wall assembly of a shower door system, according to an exemplary embodiment;

FIG. 12 shows a top cross-sectional view of a shower door system in a left center pivot configuration, according to an exemplary embodiment;

FIG. 13 shows a top cross-sectional view of a shower door system in a right wall pivot configuration, according to an exemplary embodiment;

FIG. 14 shows a top view of an overlap jamb of a shower door system, according to an exemplary embodiment; and

FIG. 15 shows a perspective view of the overlap jamb of FIG. 14.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

Referring generally to the Figures, the present disclosure relates to shower door systems for shower enclosures (e.g., bathing enclosures, shower space, showers, baths, etc. The shower door systems are configured to allow users to access the shower enclosure and to prevent undesired leaking of water from the shower enclosure. The shower door systems include a shower door that pivots (e.g., a pivot shower door, a pivoting shower door, a swinging shower door, etc.) out to an angle relative to a closed position when opened and a fixed panel adjacent to the pivot door. The shower door can be pivotably coupled (e.g., via a pivot hinge to a fixed member (e.g., a wall, a support, a frame, etc.). Pivot shower doors require adequate space for operation, and are typically provided in different configurations to accommodate various bathroom layouts. Bathroom layouts may be limited by room size, placement of bathroom fixtures (e.g., toilets, sinks, mirrors, accessories, faucets, bathtubs, lighting fixtures, vanities, etc.), walls, existing plumbing, accessibility, and/or aesthetic preferences. For example, in one bathroom layout, the arrangement of other bathroom fixtures may make it desirable for a shower door to be installed in a left entry orientation pivoting from the wall, while in another bathroom layout, space constraints may make it desirable for a shower door to be installed in a right entry orientation pivoting from the center of the shower door system. Generally, such configurations are available as separate products (e.g., stock keeping units (SKUs)) and/or include components that are specific, or unique, to a certain configuration. Thus, it would be advantageous to provide a shower door system that may be installed in a number of configurations to accommodate a wide range of bathroom layouts, and includes common components, thereby simplifying production and improving cost efficiency and/or reducing waste in manufacturing.

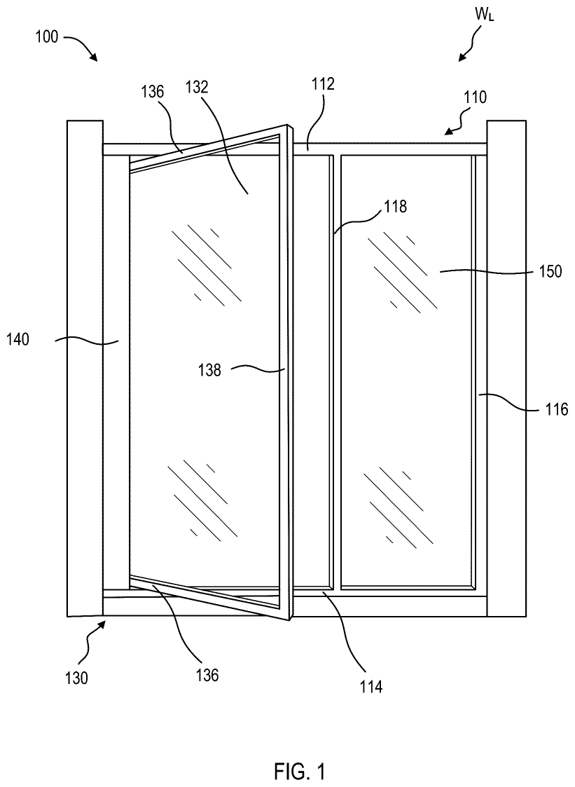

FIGS. 1-4 show a front view of an exemplary embodiment of a shower door system 100 installed in four different configurations (e.g., arrangements, set-ups, installations, etc.). The components of the shower door system 100 may be used to provide at least four different configurations. A door panel of the shower door system 100 may pivot from a left side of a shower enclosure to allow left entry, or, pivot from a right side of the shower enclosure to allow right entry. Directional left entry and right entry are with regard to viewing the shower door system 100 from outside of the shower enclosure towards a shower door and opposite a back wall of the shower enclosure. Further, the door panel may be configured to pivot about the center of the shower door system 100, or, a wall of the shower enclosure. In some embodiments, the shower door system 100 includes pivot hinges disposed at a top end and bottom end of the door panel, allowing the door panel to swing open and closed about a fixed point. In some embodiments, the door panel may swing inwards and outwards, relative to the shower enclosure, or the door panel may have a limited range of movement.

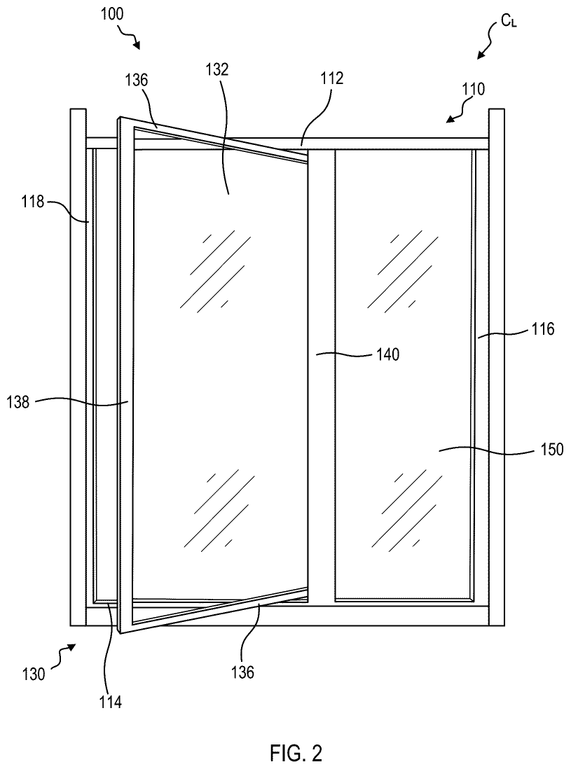

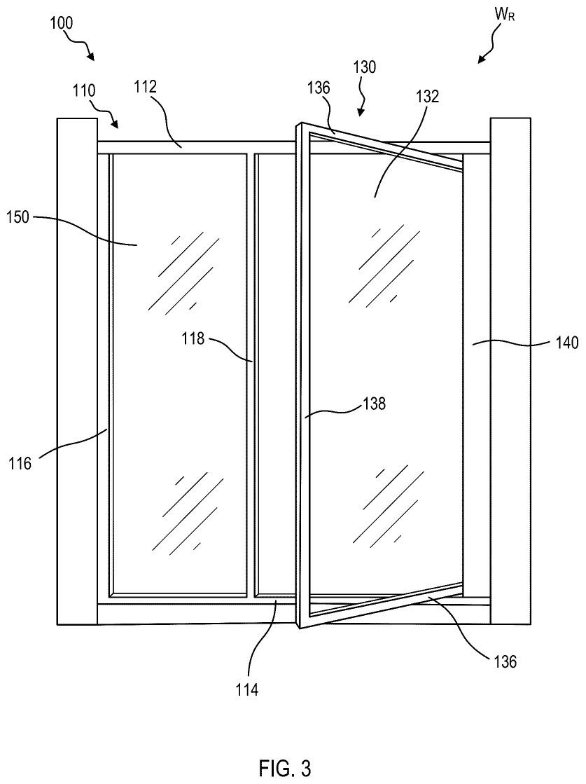

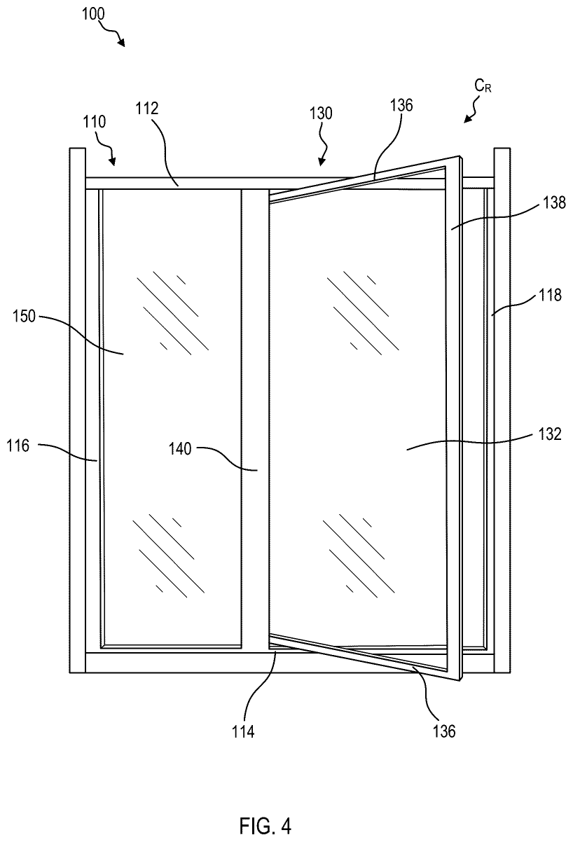

FIG. 1 shows a left entry with wall pivot configuration W_{L} of the shower door system 100. FIG. 2 shows a left entry with center pivot configuration C_{L} of the shower door system 100. FIG. 3 shows a right entry with wall pivot configuration W_{R} of the shower door system 100. FIG. 4 shows a right entry with center pivot configuration C_{R} of the shower door system 100. The reconfigurability of the shower door system 100 allows for a user (e.g., home owner, builder, etc.) to purchase the shower door system 100 and install the shower door system 100 in a configuration that is suited for the shower enclosure. While the embodiments of the shower door system 100 are shown as a shower door system 100 for a shower enclosure without a bathtub, the shower door system 100 can be used for different bathroom spaces, such as a shower enclosure with a bathtub.

In some embodiments, the shower door system 100 includes a wall assembly 110, pivot members 120, a pivot door assembly 130, an overlap jamb 140, a strike jamb 118, and a fixed panel 150. The wall assembly 110 can be configured to mount the shower door system 100 to a shower enclosure. The wall assembly 110 is installed in a similar manner in each shower door system 100 configuration (ex. W_{L}, C_{L}, W_{R}, C_{R}, etc.). For example, the wall assembly 110 in the right center pivot configuration C_{R} is the same as the wall assembly 110 in the left wall pivot configuration W_{L}, the wall assembly 110 in the left center pivot configuration C_{L}, and the wall assembly 110 in the right wall pivot configuration W_{R}. The wall assembly 110 includes a header 112 extending across the top of the shower enclosure, a threshold 114 across the bottom of the shower enclosure, and wall jambs 116 connecting the header 112 and threshold 114 at opposite ends (ex. left, right), forming a substantially rectangular frame for the shower door system 100. The header 112 and the threshold 114 can stabilize, or support, the pivot door assembly 130, as well as ensure proper alignment. In some embodiments, the wall assembly 110 may be integrally formed. In some embodiments, the header 112, threshold 114, and wall jambs 116 are separate pieces coupled (e.g., fastened, threaded, welded, etc.) together. In some embodiments, the wall assembly 110 may omit one or more of the header 112, threshold 114, and wall jambs 116.

The pivot door assembly 130 includes a door panel 132. The pivot door assembly 130 may include a plurality of frame members 136 coupled to the outer edges, or outer perimeter, of the door panel 132, as well as an integrated handle 138 on a long edge (e.g., an edge running vertically along a height of the door panel) of the door panel. In some embodiments, the door panel 132 may be frameless, or the plurality of frame members 136 may be coupled to only a portion of the outer edges of the door panel 132. The pivot door assembly 130 and overlap jamb 140 may be installed in different locations within the wall assembly 110 to provide a desired configuration (ex. W_{L}, C_{L}, W_{R}, C_{R}). The fixed panel 150 is coupled to the wall assembly 110 at an end opposite the pivot door assembly 130. In some embodiments, the fixed panel 150 may be omitted. When the fixed panel 150 is omitted, the pivot door assembly 130 may still be installed in the left wall pivot configuration W_{L} and the right wall pivot configuration W_{R}.

The pivot door assembly 130 is coupled to the wall assembly 110 via the pivot members 120 and rotates about a vertical pivot axis defined by the pivot members 120 between a closed position and an open position. The end of the pivot door assembly 130 that is proximate the pivot axis defines a fixed end of the pivot door assembly, and the opposite end distal to the pivot axis defines the free end of the pivot door assembly 130. The free end of the pivot door assembly 130 opens outwards for a user to access the shower enclosure. The strike jamb 118 is installed such that in a closed position, a free end of the pivot door assembly 130 distal to the pivot axis contacts the strike jamb 118. In some embodiments, the angle measured between a plane defined by the fixed panel 150 and a plane defined by the pivot door assembly 130 is approximately zero in a closed position. As the pivot door assembly 130 opens, the angle between the plane defined by the pivot door assembly 130 and the fixed panel 150 increases. In some embodiments, when the pivot door assembly 130 is in a maximum open position, the pivot door assembly 130 may open to an angle of about 90 degrees. In some embodiments, the pivot door assembly 130 may open to an angle of greater than 90 degrees. In some embodiments, the wall assembly 110 may include one or more dampers or damping mechanisms to control the pivoting movement of the pivot door assembly 130. In some embodiments, the pivot door assembly 130 may be coupled to the shower enclosure without the wall assembly 110, for example, by coupling directly to walls of the shower enclosure.

The overlap jamb 140 is adjacent to, and parallel to, the pivot axis. The overlap jamb 140 may be configured to couple to a wall jamb 116, as shown in FIGS. 1 and 3. Alternatively, the overlap jamb 140 may be configured to couple to the fixed panel 150, as shown in FIGS. 2 and 4.

Referring to FIG. 1, the shower door system 100 is installed in the left entry with wall pivot configuration W_{L}. To install the shower door system 100 in this configuration, the overlap jamb 140 is coupled to the left wall jamb 116, the fixed panel 150 is coupled to the right wall jamb 116, and the strike jamb 118 is coupled to the left side of the fixed panel 150. Pivot members 120 provided in the header 112 (header pivot assembly 122) and the threshold 114 (threshold pivot assembly 124) are installed proximate the overlap jamb 140 to pivotably couple the pivot door assembly 130 to the wall assembly 110. The pivot door assembly 130 is oriented such that the pivot door assembly 130 opens outwards and an integrated handle 138 coupled to the door panel 132 contacts the strike jamb 118 in a closed position, allowing a user to open the pivot door assembly 130 from the left about a pivot axis proximate a left wall of the shower enclosure.

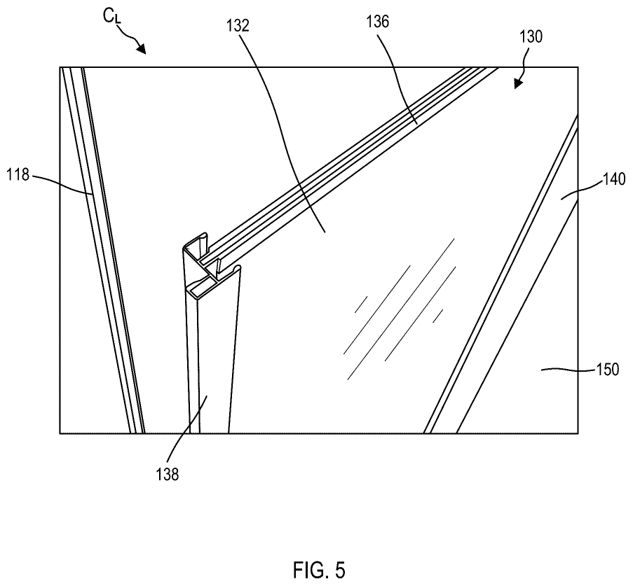

Referring to FIG. 2, the shower door system 100 is installed in the left entry with center pivot configuration C_{L}. FIG. 5 shows a top perspective view of the pivot door assembly 130 of FIG. 2. To install the shower door system 100 in this configuration, the overlap jamb 140 is coupled to the left side of the fixed panel 150 approximately near the center of the shower door system 100 and the strike jamb 118 is coupled to the left wall jamb 116. The fixed panel 150 is coupled to the right wall jamb 116. Pivot members 120 provided in the header 112 (header pivot assembly 122) and the threshold 114 (threshold pivot assembly 124) are installed proximate the overlap jamb 140 to pivotably couple the pivot door assembly 130 to the wall assembly 110. The pivot door assembly 130 is oriented such that the pivot door assembly 130 opens outwards and an integrated handle 138 coupled to the door panel 132 contacts the strike jamb 118 in a closed position, allowing a user to open the pivot door assembly 130 from the left about a pivot axis proximate the center of the shower door system 100.

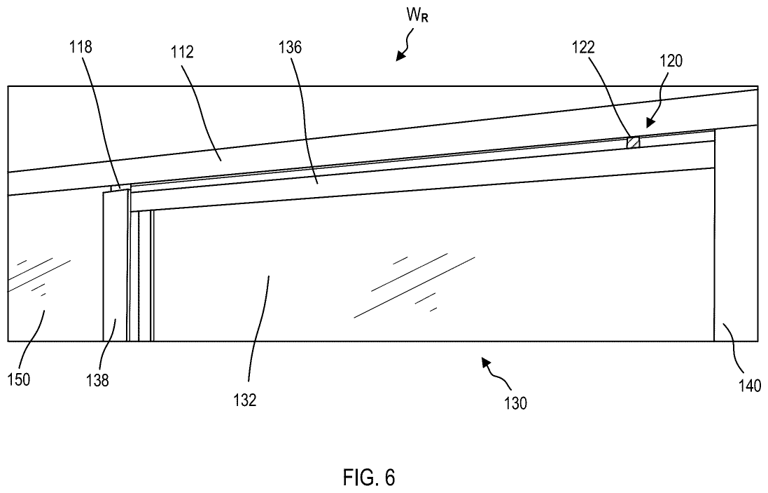

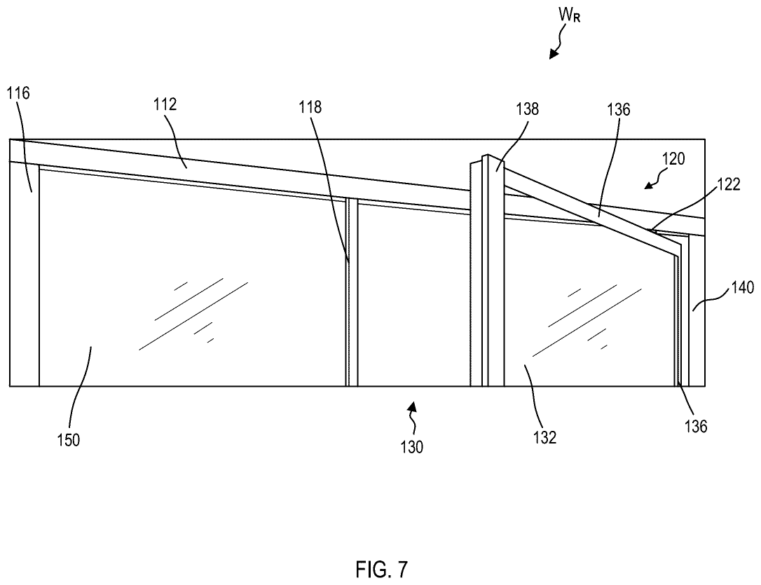

Referring to FIG. 3, the shower door system 100 is installed in the right entry with wall pivot configuration W_{R}. FIG. 6 shows a perspective view of a top portion of the configuration shown in FIG. 3, in the closed position, and FIG. 7 shows a perspective view the configuration in the open position. To install the shower door system 100 in this configuration, the overlap jamb 140 is coupled to the right wall jamb 116, the fixed panel 150 is coupled to the left wall jamb 116 on the left side, and the strike jamb 118 is coupled to the right side of the fixed panel 150. Pivot members 120 provided in the header 112 (header pivot assembly 122) and the threshold 114 (threshold pivot assembly 124) are installed proximate the overlap jamb 140 to pivotably couple the pivot door assembly 130 to the wall assembly 110. The pivot door assembly 130 is oriented such that the pivot door assembly 130 opens outwards and an integrated handle 138 coupled to the door panel 132 contacts the strike jamb 118 in a closed position, allowing a user to open the pivot door assembly 130 from the right about a pivot axis proximate a right wall of the shower enclosure.

Referring to FIG. 4 the shower door system 100 is installed in the right entry with center pivot configuration C_{R}. To install the shower door system 100 in this configuration, the overlap jamb 140 is coupled to the right side of the fixed panel 150 approximately near the center of the shower door system 100 and the strike jamb 118 is coupled to the right wall jamb 116. The fixed panel 150 is coupled to the left wall jamb 116. Pivot members 120 provided in the header 112 (header pivot assembly 122) and the threshold 114 (threshold pivot assembly 124) are installed proximate the overlap jamb 140 to pivotably couple the pivot door assembly 130 to the wall assembly 110. The pivot door assembly 130 is oriented such that the pivot door assembly 130 opens outwards and an integrated handle 138 coupled to the door panel 132 contacts the strike jamb 118 in a closed position, allowing a user to open the pivot door assembly 130 from the right about a pivot axis proximate the center of the shower door system 100.

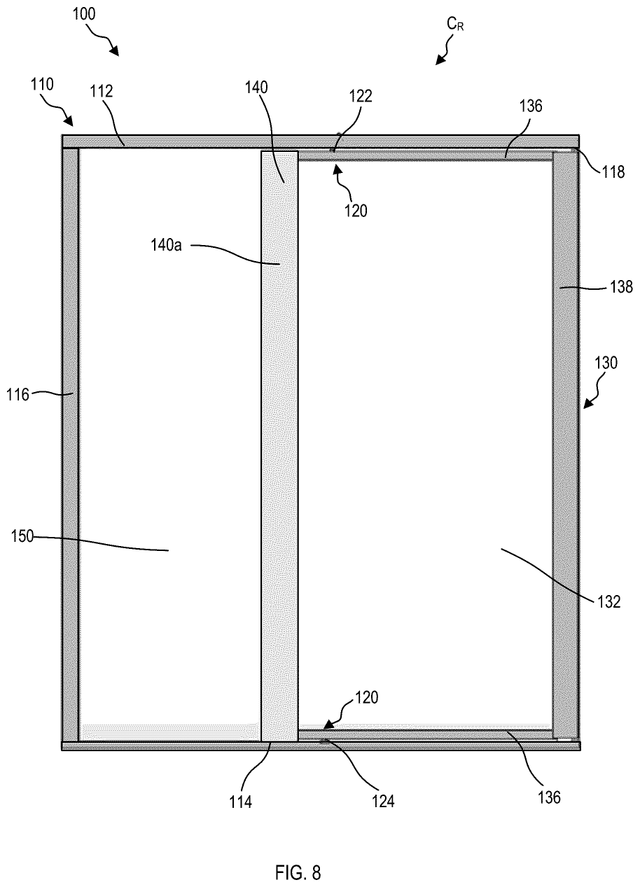

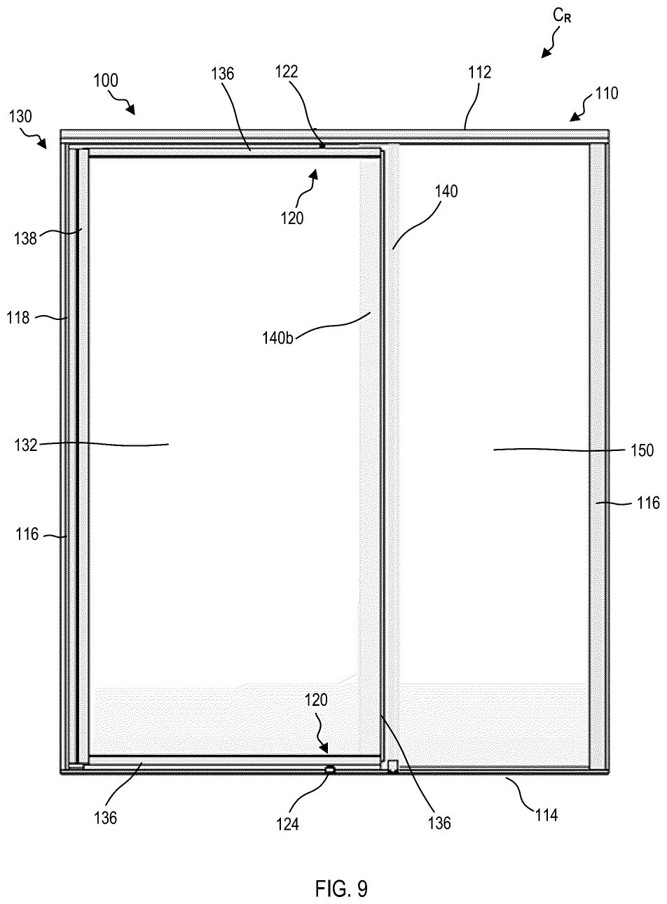

FIGS. 8-9 depict the shower door system 100 according to another exemplary embodiment. While the configuration depicted in FIGS. 8-9 depicts a right entry with center pivot configuration C_{R}, the configuration of FIGS. 8-9 can be mirrored vertically to operate as a left-entry with center pivot configuration C_{L}. The shower door system 100 in FIGS. 8-9 is structurally and/or functionally similar to the shower door system 100 shown in FIGS. 1-4. The shower door system 100 includes a wall assembly 110. The wall assembly 110 is made from a substantially rigid material to provide structural support for the shower door system 100. The wall assembly 110 includes a header 112, a threshold 114, and wall jambs 116 coupled to one another to form a frame. In some embodiments, the header 112, threshold 114, and wall jambs 116 may be coupled via one or more bracket assemblies or by one or more fasteners (e.g., bolts, screws, adhesive, etc.). In some embodiments, the wall assembly 110 may be formed as a single piece. In some embodiments, one or more of the header 112, threshold 114, and wall jambs 116 may be omitted. The wall assembly 110 is coupled to a stationary/fixed structure, such as the walls of a shower enclosure, and frames the opening of the shower enclosure. The wall assembly 110 may be coupled to the stationary structure using one or more bracket assemblies.

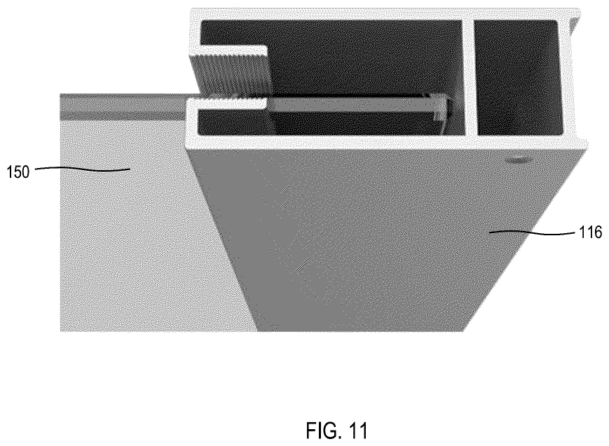

The header 112 has a substantially linear shape and is fixedly coupled between horizontally parallel points of the shower enclosure via a mounting assembly. The header 112 extends across the top of a width of the opening of the shower enclosure and defines an upper perimeter and width of the wall assembly 110. In some embodiments, the header 112 may be made of separate pieces coupled (e.g., threaded, welded, brazed, etc.) together. The header 112 is coupled to wall jambs 116 on opposite ends (ex. left, right) of the header 112. The wall jambs 116 define the side perimeters and height of the wall assembly 110. The wall jambs 116 are substantially linear and disposed in the same plane as the header 112, perpendicular to the header 112, and are configured to couple to the walls of the shower enclosure. In some embodiments, the wall jambs 116 may be made of separate pieces coupled (e.g., threaded, welded, brazed, etc.) together. In some embodiments, as illustrated in FIG. 11, the wall jambs 116 may include a channel configured to receive the fixed panel 150. In some embodiments, the wall jambs 116 are secured to the walls of the shower enclosure via fasteners (e.g., screws, adhesive, etc.). The wall jambs 116 are also coupled to the threshold 114 spanning the bottom of the width of the opening of the shower enclosure. The threshold 114 defines the bottom perimeter of the wall assembly 110, and is approximately the same width as the header 112. In some embodiments, the threshold 114 may be made of separate pieces coupled (e.g., threaded, welded, brazed, etc.) together. In some embodiments, the wall jambs 116 are coupled to the threshold 115 by one or more fasteners (e.g., bolts, screws, adhesive, etc.).

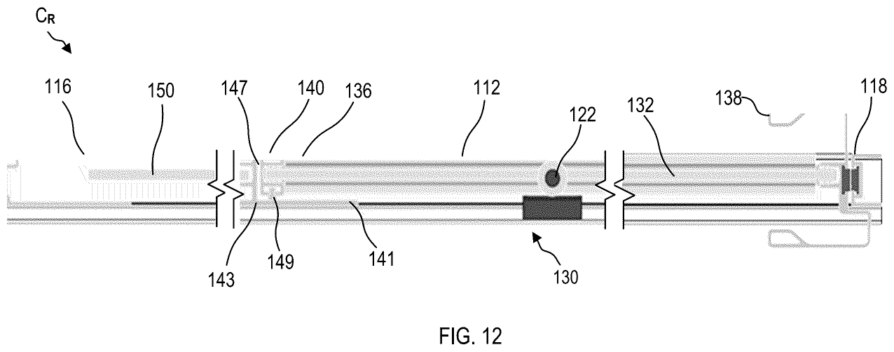

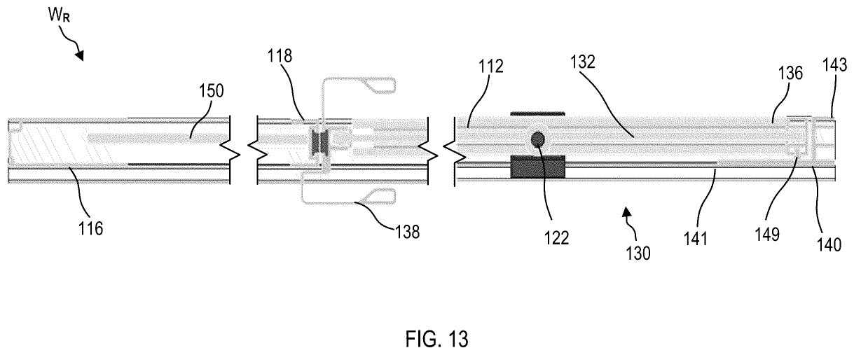

The shower door system 100 includes a pivot door assembly 130 placed within the wall assembly 110 and coupled to the wall assembly 110 by pivot members 120 including a header pivot assembly 122 and a threshold pivot assembly 124. In some embodiments, the header pivot assembly 122 or the threshold pivot assembly 124 may be omitted. The installation placement and orientation of the pivot door assembly 130 provide different configurations of the shower door system 100 (ex. W_{L}, C_{L}, W_{R}, C_{R}, etc.). For example, in FIG. 12, the pivot door assembly 130 is installed in a left center pivot configuration C_{L}, and in FIG. 13, the pivot door assembly is installed in a right wall pivot configuration W_{R}. The pivot door assembly 130 defines the door opening (e.g., a space, a gap, etc.) in the shower door system 100. The pivot door assembly 130 is configured to pivot about a generally vertical pivot axis between the open and closed position to allow a user to enter or exit the shower enclosure during use. The pivot door assembly 130 may be substantially planar, however, in other embodiments, the pivot door assembly 130 may be substantially non-planar, or include non-planar portions.

The pivot door assembly 130 includes a door panel 132. The door panel 132 may be formed of glass, such as tempered glass or laminated glass, or other rigid material (e.g., acrylic, wood, metal, plastic, etc.), or combination of materials. The door panel 132 may be provided in a number of thicknesses (e.g., 1/16 in., ⅛ in., 3/16 in., ¼ in., ⅜ in., ½ in., etc.) In some embodiments, the door panel 132 made of a transparent or translucent material. As illustrated in the Figures, the door panel 132 may be substantially rectangular. However, in other embodiments, the door panel 132 may be another shape. In some embodiments, the pivot door assembly 130 includes an integrated handle 138 coupled to the door panel 132 to provide a surface for a user to grasp to open and close the pivot door assembly 130 as they enter and exit the shower enclosure.

The door panel 132 may include a plurality of frame members (e.g., rails, supports, etc.) 136 coupled to the sides (e.g., top, bottom, right, left, etc.) of the door panel 132. The plurality of frame members 136 may surround the perimeter of the door panel 132 or surround only a portion of the door panel 132. In some embodiments, the door panel 132 and the plurality of frame members 136 may be provided pre-assembled. The plurality of frame members 136 may include channels or grooves to receive the door panel 132. The plurality of frame members 136 may be coupled to the door panel 132 by one or more fasteners (e.g., bolts, nuts, rivets, adhesive, etc.). The plurality of frame members 136 are made of a substantially rigid material or combination of rigid materials to support the door panel 132 and pivot door assembly 130. For example, the plurality of frame members 136 may be formed from a rigid such as metal (e.g., aluminum, brass, steel, etc.) or plastic. In some embodiments, the door panel 132 may be frameless. In some embodiments, a gasket, or seal may be provided between an interface of the shower door system 100 and the door panel 132, such as on the bottom edge of the door panel 132. A seal may be coupled (e.g., glued, bonded, press-fit, etc.) to a frame member 136 disposed on the bottom edge of the door panel 132 to prevent water or other fluids from leaking from the within the shower enclosure between the door panel 132 and threshold 114.

The pivot door assembly 130 contacts a strike jamb 118 in a closed position. More specifically, the free end of the pivot door assembly 130 contacts the strike jamb 118, when the door panel 132 is in a closed position. The strike jamb 118 is installed dependent on the desired configuration of pivot door assembly 130 such that strike jamb 118 is co-located with the free end of the door panel 132 in a closed position. For example, as seen in FIGS. 2 and 4, the strike jamb 118 may be coupled to a wall jamb 116 as the door panel 132 pivots above the center of the shower door system 100. As shown in FIGS. 1 and 3, the strike jamb 118 may also be coupled to the fixed panel 150 near the center of the shower door system 100. In some embodiments, the strike jamb 118 may include a magnetic closure configured to engage with a magnetic enclosure on the integrated handle 138 to facilitate closing. In some embodiments, the strike jamb 118 and the integrated handle 138 may include a latching mechanism. In some embodiments closing mechanisms may be used. In some embodiments, no additional latching or closing mechanisms are provided. In some embodiments, the strike jamb 118 and/or the integrated handle 138 may include a sealing member (e.g., seal, gasket, etc.) configured to allow the strike jamb 118 and the integrated handle 138 to form a watertight seal when the door panel 132 is in a closed position.

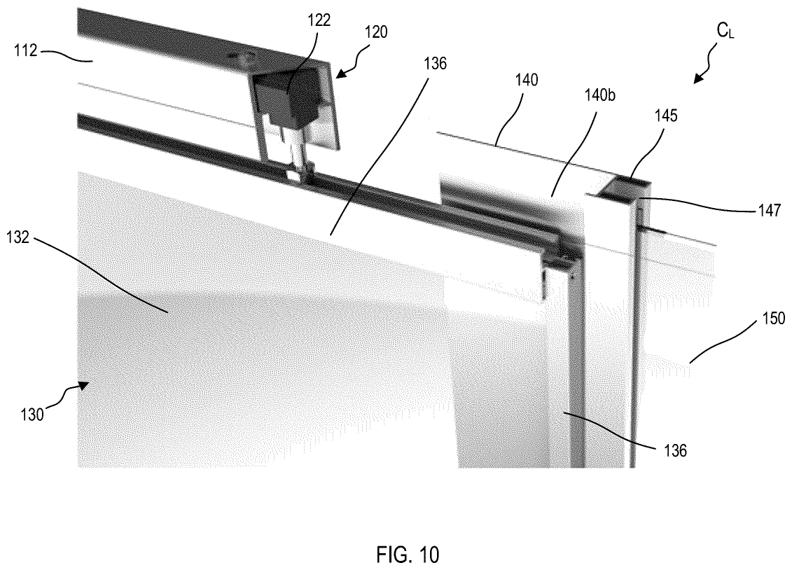

The pivot door assembly 130 is coupled to the header 112 via a header pivot assembly 122. A portion of the header pivot assembly 122 is received within the header 112 and couples to the header 112 and the pivot door assembly 130. In some embodiments, as shown in FIG. 10, the header 112 includes a channel configured to receive a portion of the header pivot assembly 122. In some embodiments, the header pivot assembly 122 can be fixedly coupled to the header 112 using one or more fasteners. In some embodiments, stability blocks are disposed between the pivot door assembly 130 and header 112 to stabilize the pivot door assembly 130 within the wall assembly 110. The header pivot assembly 122 defines the pivot axis about which the pivot door assembly 130 rotates. The header pivot assembly 122 is configured to rotate the pivot door assembly 130 relative to the wall assembly 110.

The pivot door assembly 130 is coupled to the threshold 114 via a threshold pivot assembly 124. A portion of the threshold pivot assembly 124 is received within the threshold 114 and couples to the pivot door assembly 130. The threshold pivot assembly 124 defines a pivot axis aligned with the pivot axis defined by the header pivot assembly. Similar to the header pivot assembly 122, the threshold pivot assembly 124 is configured to rotate the pivot door assembly 130 relative to the wall assembly 110.

The pivot axis defined by the pivot members 120 lies adjacent to, and substantially parallel to, an edge of the overlap jamb 140. In some embodiments, the pivot axis is an axis connecting the header pivot assembly 122 and the threshold pivot assembly 124. The overlap jamb 140 may be coupled to a wall jamb 116 or coupled to the fixed panel 150. The overlap jamb 140 is disposed proximate the fixed end of the pivot door assembly 130, opposite the strike jamb 118. As the overlap jamb 140 is shaped to couple to a wall jamb 116 or attach to the fixed panel 150, the shower door system 100 may be easily installed in different configurations (ex. W_{L}, C_{L}, W_{R}, C_{R}, etc.).

The overlap jamb 140 may be installed near the center of the wall assembly 110 and coupled to a frame member 136 of the pivot door assembly 130 in the right center pivot configuration C_{R} of the shower door system 100. The strike jamb 118 is coupled to the wall jamb 116 proximate the free end of the pivot door assembly 130. In some embodiments, the strike jamb 118 is coupled to the threshold 114 by one or more mounting assemblies. A front surface 140a of the overlap jamb 140 is installed to face outwards from the shower enclosure, and the coupling surface 140b of the overlap jamb 140 faces the shower enclosure.

The shower door system 100 includes a fixed panel 150 adjacent to the pivot door assembly 130. The fixed panel 150 may be used to fully enclose the shower enclosure. In some embodiments, the fixed panel 150 may be omitted. The fixed panel 150 is disposed on a side of the overlap jamb 140 opposite the pivot door assembly 130. The fixed panel 150 is coupled to the header 112 on a top edge, one of the wall jambs 116 on a side edge, and the threshold 114 on a bottom edge. The remaining edge may be coupled to the strike jamb 118 or the overlap jamb 140, depending on the desired configuration. In some embodiments, the fixed panel may be coupled to the shower enclosure without one or more of the header 112, threshold 114, or wall jamb 116. The fixed panel 150 remains static in use. The fixed panel 150 may be formed of similar material to the door panel 132, and may have an appearance that is similar to, or, complementary to the door panel 132. The fixed panel 150 may be formed of glass (e.g., tempered glass, laminated glass, etc.), or other rigid material (e.g., acrylic, wood, metal, plastic, etc.), or combination of materials. In some embodiments, the fixed panel 150 is made of a transparent or translucent material. As illustrated in the Figures, the fixed panel 150 may be substantially rectangular. However, in other embodiments, the fixed panel 150 may be another shape.

FIGS. 12 and 13 depict a shower door system 100 according to another exemplary embodiment. The shower door system 100 in FIGS. 12-13 is structurally and/or functionally similar to the shower door system 100 shown in FIGS. 1-4 and FIGS. 8-9. As shown in FIG. 12, in the right center pivot configuration C_{R}, the overlap jamb 140 is coupled to the right side of the fixed panel 150. The fixed panel 150 is coupled to the left wall jamb 116. The header pivot assembly 122 pivotably couples the pivot door assembly 130 to the header 112. The pivot door assembly 130 is oriented such that the pivot door assembly 130 opens outwards and the integrated handle 138 coupled to the door panel 132 contacts the strike jamb 118 in a closed position, allowing a user to open the pivot door assembly 130 from the right about a pivot axis proximate the center of the shower door system 100.

As shown in FIG. 13, in the right wall pivot configuration W_{R}, the overlap jamb 140 is coupled to the right wall jamb 116, the fixed panel 150 is coupled to the left wall jamb 116, and the strike jamb 118 is coupled to the right side of the fixed panel 150. The header pivot assembly 122 pivotably couples the pivot door assembly 130 to the header 112. The pivot door assembly 130 is oriented such that the pivot door assembly 130 opens outwards and the integrated handle 138 coupled to the door panel 132 contacts the strike jamb 118 in a closed position, allowing a user to open the pivot door assembly 130 from the right about a pivot axis proximate the right wall of the shower enclosure. As illustrated in FIGS. 12-13, a seal member 149 may be disposed in a space between the frame member 136 and the overlap jamb 140 to position the door panel 132 and the fixed panel 150 in the same plane.

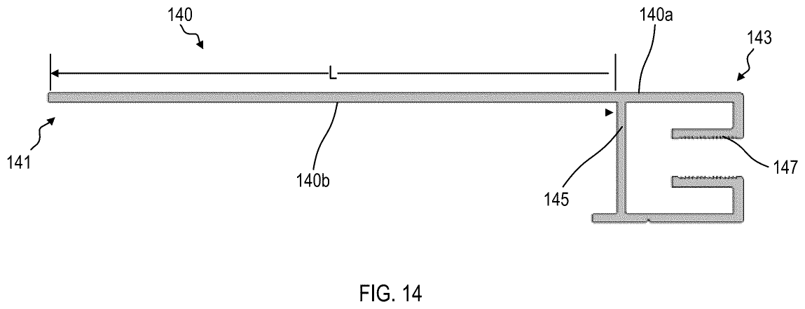

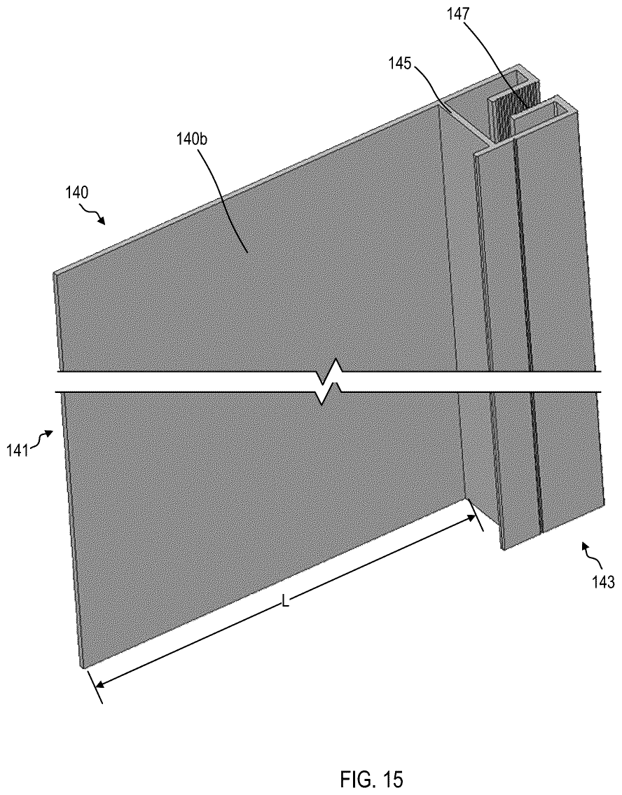

Referring to FIGS. 14-15, the overlap jamb 140 of the shower door system 100, according to an exemplary embodiment, is shown in detail. The overlap jamb 140 is an L-shaped member having the same height as the wall jambs 116. The overlap jamb 140 includes a substantially flat front surface 140a that faces outward from the shower enclosure. The overlap jamb 140 includes an attachment member 145 on a back surface extending perpendicularly away from the front surface 140a at one end. The attachment member 145 includes two protrusions defining a channel 147 configured to receive a panel, such as the fixed panel 150. The overlap jamb 140 includes a coupling surface 140b opposite the front surface 140a extending between an outer edge of the overlap jamb 140 and an inner edge of the attachment member 145. The coupling surface 140b abuts the pivot door assembly 130, and may be coupled to one of the frame members 136 or coupled to the fixed panel 150, depending on the desired configuration. The L-shape of the overlap jamb 140 allows for the pivot door assembly 130 to contact the coupling surface 140b of the overlap jamb 140 when the pivot door assembly 130 is in a closed position and for the pivot door assembly to rotate away from the overlap jamb 140 when the pivot door assembly 130 is in an open position. In some embodiments, the pivot door assembly 130 and the coupling surface 140b of the overlap jamb 140 form a seal when the pivot door assembly 130 is in a closed position.

The overlap jamb 140 includes a pivot end 141 and a fixed end 143 on the opposite end. The attachment member 144 and channel 147 are disposed at the fixed end 143 to receive the fixed panel 150 or couple to the wall jamb 116. The coupling surface 140b defines a distance L between the inner edge of the attachment member 145 and the pivot end 141 that allows for adjustment of spacing between the overlap jamb 140 and the pivot door assembly 130, or the spacing between the overlap jamb 140 and the wall jamb 116.

It should be noted that the term “example” as used herein to describe various embodiments is intended to indicate that such embodiments are possible examples, representations, and/or illustrations of possible embodiments.

Various numerical values herein are provided for reference purposes only. Unless otherwise indicated, all numbers expressing quantities of properties, parameters, conditions, and so forth, used in the specification and claims are to be understood as being modified in all instances by the term “about” or “approximately.” Accordingly, unless indicated to the contrary, the numerical parameters set forth in the following specification are approximations. Any numerical parameter should at least be construed in light of the number reported significant digits and by applying ordinary rounding techniques. The term “about” or “approximately” when used before a numerical designation, e.g., a quantity and/or an amount including range, indicates approximations which may vary by (+) or (−) 10%, 5%, or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, assembly and arrangement of the various exemplary embodiments without departing from the scope of the embodiments described herein.

While this specification contains implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A shower door system, comprising:
a wall assembly configured to fixedly couple the shower door system to walls of a showering enclosure
a fixed panel coupled to the wall assembly,
a door panel pivotably coupled to the wall assembly by a pivot assembly defining a pivot axis, the door panel configured to pivot about the pivot axis between an open position and a closed position; and
an overlap jamb coupled to the wall assembly adjacent a pivoting end of the door panel, the overlap jamb defining a coupling surface couplable to the showering enclosure, in a first configuration, and couplable to the fixed panel, in a second configuration.

2. The shower door system of claim 1, wherein the door panel is symmetric about a horizontal central axis.

3. The shower door system of claim 1, wherein the door panel and the overlap jamb form a seal when the door panel is in the closed position.

4. The shower door system of claim 3, wherein the seal is formed by a seal member disposed between the door panel and the overlap jamb.

5. The shower door system of claim 1, wherein the overlap jamb is an L-shaped extrusion.

6. The shower door system of claim 1, wherein the door panel further comprises one or more frame members along a perimeter of the door panel.

7. The shower door system of claim 6, wherein the one or more frame members includes an integrated handle.

8. The shower door system of claim 7, wherein the integrated handle includes a closing mechanism.

9. The shower door system of claim 8, wherein the closing mechanism is magnetic.

10. A shower system, comprising:
a showering enclosure;
a wall assembly configured to be coupled to support walls of the showering enclosure comprising:
a member spanning a width of the showering enclosure; and
at least one wall jamb;
a fixed panel coupled to the wall assembly,
a door panel pivotably coupled to the wall assembly by a pivot assembly defining a pivot axis,
the door panel configured to pivot about the pivot axis between an open position and a closed position; and
an overlap jamb coupled to the wall assembly adjacent a pivoting end of the door panel, the overlap jamb defining a coupling surface couplable to the at least one wall jamb, in a first configuration, and couplable to the fixed panel, in a second configuration.

11. The shower system of claim 10, wherein the door panel is symmetric about a horizontal central axis.

12. The shower system of claim 10, wherein the door panel and the overlap jamb form a seal when the door panel is in the closed position.

13. The shower system of claim 12, wherein the seal is formed by a seal member disposed between the door panel and the overlap jamb.

14. The shower system of claim 10, wherein the overlap jamb is an L-shaped extrusion.

15. A shower door system, comprising:
a wall assembly configured to support and couple a pivot door assembly to a showering enclosure defining an opening, the wall assembly configured to secure to walls of the showering enclosure, the wall assembly including an overlap jamb movable between a first configuration and a second configuration, the overlap jamb comprising:
a member having a front surface that is substantially flat and a coupling surface opposite the front surface, the coupling surface being coupled to the walls of the showering enclosure in the first configuration;
an attachment member extending away from the front surface, the attachment member forming a channel;
a fixed panel coupled to the wall assembly, wherein the attachment member is configured to receive the fixed panel in the channel in the second configuration; and
a door panel pivotably coupled to the wall assembly by a pivot assembly defining a pivot axis, the pivot axis being parallel to and adjacent to a length of the overlap jamb, the door panel configured to pivot about the pivot axis between an open position and a closed position.

16. The shower door system of claim 15, wherein the door panel is symmetric about a horizontal central axis.

17. The shower door system of claim 15, wherein the door panel and the overlap jamb form a seal when the door panel is in the closed position.

18. The shower door system of claim 17, wherein the seal is formed by a seal member disposed between the door panel and the overlap jamb.

19. The shower door system of claim 15, wherein the door panel further comprises one or more frame members along a perimeter of the door panel.

20. The shower door system of claim 15, wherein the one or more frame members includes an integrated handle.
